(19) United States
(12) Patent Application Publication
(10) Pub. No.: US 2019/0200806 A1
(43) Pub. Date: Jul. 4, 2019

(54) GRILL BAG

(71) Applicant: Charcoal Companion Incorporated, Berkeley, CA (US)

(72) Inventors: Cory Thomas Borovicka, Oakland, CA (US); Nicholas Wood Allen, San Francisco, CA (US)

(21) Appl. No.: 16/129,659

(22) Filed: Sep. 12, 2018

Related U.S. Application Data
(63) Continuation-in-part of application No. 29/632,048, filed on Jan. 4, 2018, now Pat. No. D839653.
Application No. 29/632,048 is a continuation-in-part of application No. 29/659,275, filed on Aug. 7, 2018.
(60) Provisional application No. 62/717,734, filed on Aug. 10, 2018.

(51) Int. Cl. A47J 37/07; B65D 81/34; B65D 33/24

(52) U.S. Cl. CPC A47J 37/0786; B65D 33/24; B65D 81/3407

(57) ABSTRACT

A grill bag for cooking small food items, such as pieces of meat, seafood or vegetables, on a barbecue grill or the like is in the form or is formable into a pouch. The pouch is formed from a piece of flexible, high temperature resistant material having distributed mesh openings. The pouch of the grill bag can be loaded with small food items and the loaded grill bag easily set onto and removed from a barbecue grill and easily moved or turned over on the grill to efficiently and evenly cook the food items contained in the grill bag.

### CROSS-REFERENCE TO RELATED APPLICATIONS

This application is a continuation-in-part of U.S. Design patent application No. 29/632,048, filed Jan. 4, 2018, and U.S. Design patent application No. 29/659,275, filed Aug. 7, 2018, both of which are now pending, and claims the benefit of U.S. Provisional Patent Application No. 62/717,734, filed Aug. 10, 2018.

### BACKGROUND

The present invention generally relates to barbecue accessories, and more particularly to accessories for cooking small or delicate food items over a barbecue grill or the like.

In order to cook small food items on a barbecue grill, the food items need to be held together or contained in such a way that they won't fall through the space between the grates of the grill. One common approach to holding small food items together on a grill is to insert them on a skewer and then lay the skewered food items on the grill grate. However, this method has several shortcomings. First, considerable effort must be spent preparing the skewers prior to grilling. The raw food items must be manually loaded onto each skewer, and in the case of wooden skewers the skewers are preferably soaked in water to avoid burning. Also, during the grilling and handling process, delicate food items can easily fall off the skewers, especially if they stick to the hot grates of the grill. After grilling, the cooked food items must be manually pulled from each skewer and any food items that are stuck to or have fallen between the grates of the grill necessitate additional cleanup effort.

Other commonly used accessories for cooking small food items over a barbecue grill include grill pans. Although grill pans overcome some of the limitations of skewers, they are generally made of a rigid metal, most commonly stainless steel, and have a bulky form factor that makes them more difficult than skewers to clean and to store. Also, turning all the food items over in the pans for uniform grilling on both sides of the food items is not easily done, as the stirring or shaking action required to turn the food items often results in some food items not being turned or being turned too much. To get all of the food items turned over in a uniform manner takes patience and time, and tends to cause the food items to be cooked unevenly because they spend different times in their turned orientation.

Mesh grilling sheets are an alternative to skewers and grill pans. Mesh grilling sheets have a lower profile compared to grilling pans and require less preparation effort compared to skewers, but they can be cumbersome to handle on and off the grill. In addition, during cooking and handling, food items placed on the mesh grilling sheets can easily fall off the edges of the sheets and through the grates of the grill. Turning the food items on the mesh screens also faces the same difficulties encountered with the use of grill pans: to get all of the food items turned takes patience and time, and tends to cause the food items to be cooked unevenly.

### SUMMARY OF THE INVENTION

The present invention is directed to a grill bag for cooking small or delicate food items on a barbecue grill or the like that overcomes the disadvantages of conventional grilling accessories such as skewers, grill pans and screens. The grill bag of the invention can be used to cook a wide variety of food items, for example, small pieces of meat, seafood and vegetables.

The grill bag in accordance with the invention is in the form of or can be formed into a pouch comprising one or more pieces of flexible, high temperature resistant material having distributed mesh openings through which heat from the barbecue can readily pass. Preferably, the mesh openings extend over substantially the entirety of the pouch; however, it is contemplated that the mesh openings can extend over only a portion of the pouch, such as over just one side of the pouch, to enable the user to achieve different cooking rates by changing the orientation of the grill bag on the grill. The formed pouch provides an inner pocket in which small food items are contained and this inner pocket is preferably shallow or tight enough to keep the food items in a constant orientation when the pouch is moved or turned over on the grill.

The grill bag of the invention is reusable, easy to clean, and safer and easier to handle than conventional grilling accessories. It can be handled with one hand using a pair of tongs or an oven mitt and can easily be flipped over to evenly cook both sides of the contained food items. The grill bag holds the small food items together in the inner pocket of the pouch and prevents the food items from sticking to or falling through the grates of the grill, minimizing cleanup efforts. Additionally, the mesh openings allow smoke to pass through to the contained food items as they cook, giving them desirable smoke flavor.

### BRIEF DESCRIPTION OF THE DRAWINGS

FIG. 1 is a top perspective view of a grill bag in accordance with the invention.

FIG. 2A is a top plan view thereof, showing the grill bag in an open configuration.

FIG. 2B is a top plan view thereof, showing the grill bag in a closed configuration.

FIG. 3 is a top perspective view thereof, illustrating how the grill bag can be used to cook small or delicate food items on the cooking surface of a barbecue grill or the like.

FIG. 4 is a top perspective view of another embodiment of a grill bag in accordance with the invention, wherein the grill bag can be opened up from a pouch configuration to an open, flat configuration that allows the grill bag to be used to cook larger food items.

FIG. 5A is a top plan view thereof, showing the grill bag in a closed, pouch configuration.

FIG. 5B is a top plan view thereof, showing the grill bag in an open configuration.

FIG. 5C is a top plan view of yet another grill bag in accordance with the invention, this example having mesh material on only one side of the grill bag.

FIG. 6 is a top perspective view thereof, illustrating how the grill bag can be used to cook small or delicate food items on the cooking surface of a barbecue grill or the like.

### DETAILED DESCRIPTION OF THE ILLUSTRATED EMBODIMENTS

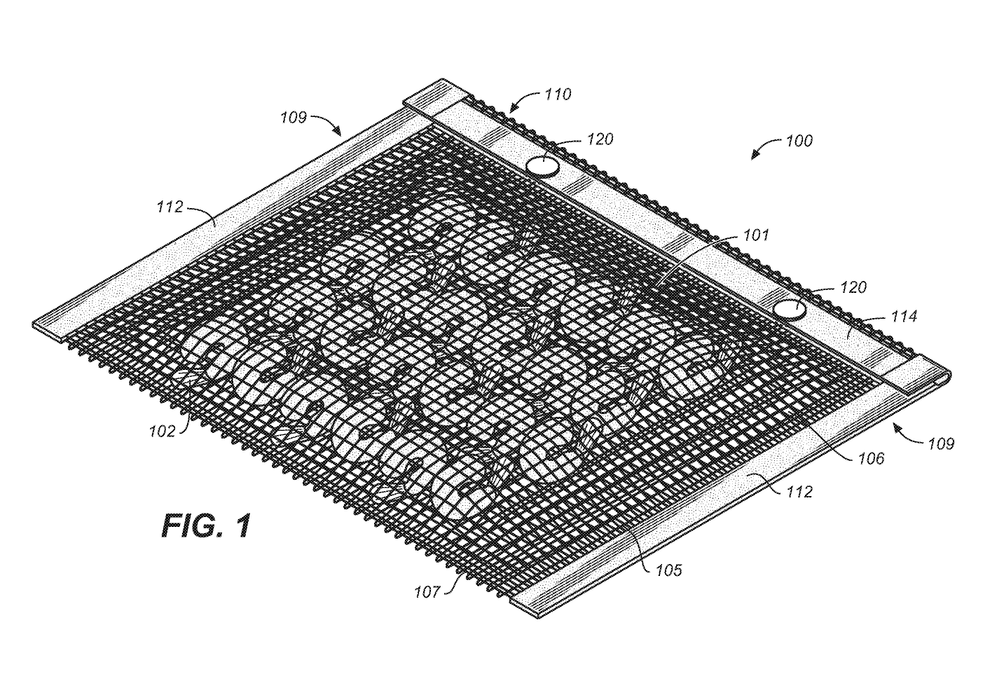

Referring now to the drawings, FIGS. 1-3 show a grill bag 100 for cooking small or delicate food items on a barbecue grill or the like. The grill bag 100 is in the form of a pouch 101 most suitably formed from a single piece of flexible, high temperature resistant material 105 having distributed mesh openings 106. It is seen that the distributed openings in this case extend substantially over the entirety of the material from which the pouch is formed as the material used to form the pouch is a mesh material. However, as later described, the heat resistant material used to form the pouch need not be entirely mesh with mesh openings throughout the material, but can be a heat resistant material with mesh openings distributed over only a portion of the material or a combination of a heat resistant mesh material and a closed heat resistant non-mesh material. Also, while the grill bag illustrated in FIGS. 1-3 is formed from a single piece of flexible, high temperature resistant mesh material, it is contemplated that the grill bag can alternatively be formed from multiple pieces joined together with suitable fastening means. The high temperature resistant materials used to form the pouch, whether mesh, partially mesh or non-mesh, can suitably be a polytetrafluoroethylene (PTFE) coated fiberglass material. In the case of a totally mesh material, this would be a PTFE coated fiberglass mesh.

The pouch 101 of the grill bag illustrated in FIGS. 1-3 can be loaded with small food items and set on a barbecue grill or the like to cook the food items contained within the pouch. In FIG. 1, the illustrated food items are seen to be small shrimp 102, but the grill bag could be used to cook many different food items, such as small pieces of meat and/or vegetables, and other types of seafood.

The grill bag of FIGS. 1-3 is a pre-formed pouch. Here, a folded over a piece of mesh material results in a closed bottom fold edge 107, longitudinal border edges 109, and a top end 110, which is not closed but which rather provides the pouch with an open mouth 130. The longitudinal border edges 109 are sealed together with a high temperature resistant sealing means such as, for example, tape 112 made of a high temperature resistant fiberglass fabric and a high temperature resistant adhesive. This folded-over configuration results in a pouch having a shallow, tight inner pocket 115 capable of keeping food items constant position and orientation within the pocket. This has the advantage of preventing food items from turning over or substantially shifting within the pocket when the grill bag is moved or turned over on the grill.

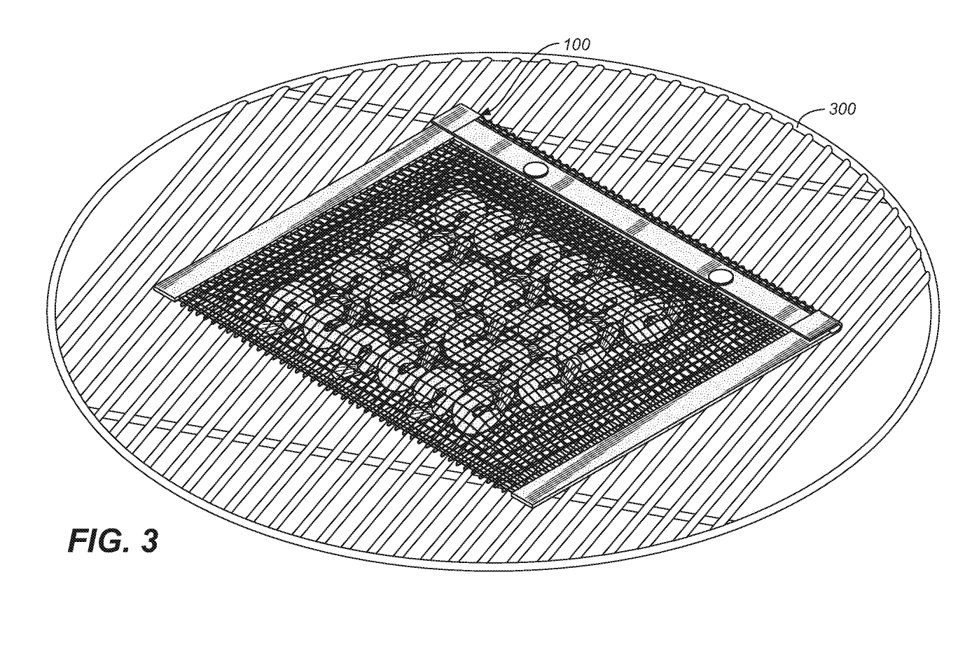

To use the pouch shown in FIGS. 1-3, small food items are simply inserted into the pouch's inner pocket 115 through the pouch's open mouth 130. FIG. 3 shows the grill bag 100 filled with small food items and placed in one orientation on the grill grate of a barbecue grill 300 for cooking one side of the food items. When turned upside down, the opposite side of the food items are cooked. And when turned upside down, the opposite side of the food items all the food items will turn and will hit the grill grate at the roughly the same time so that they are evenly cooked.

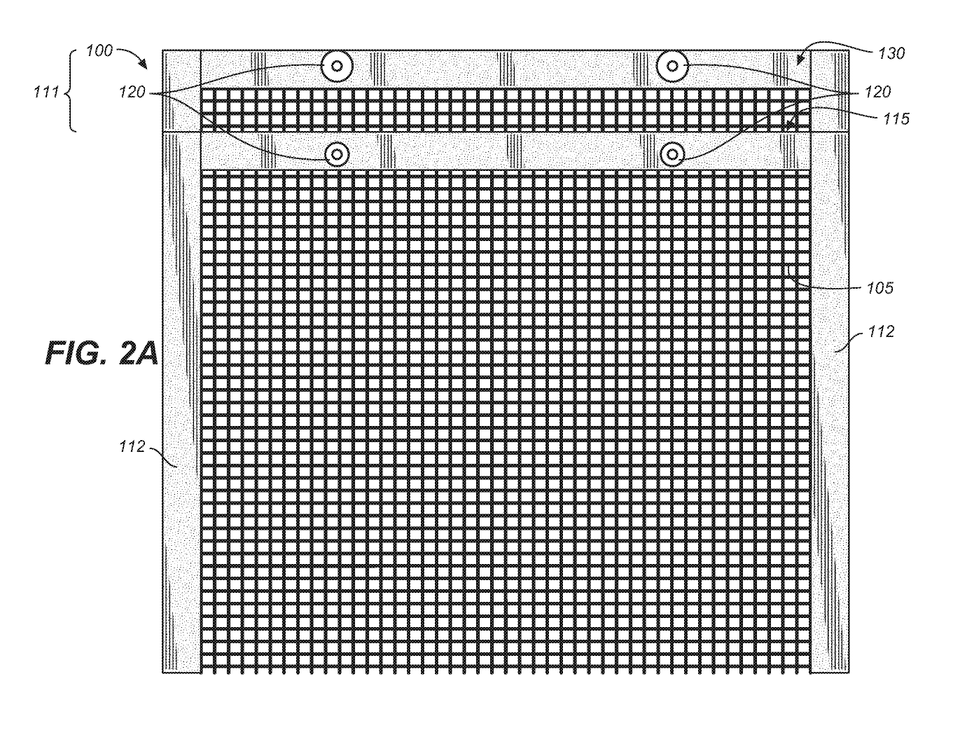

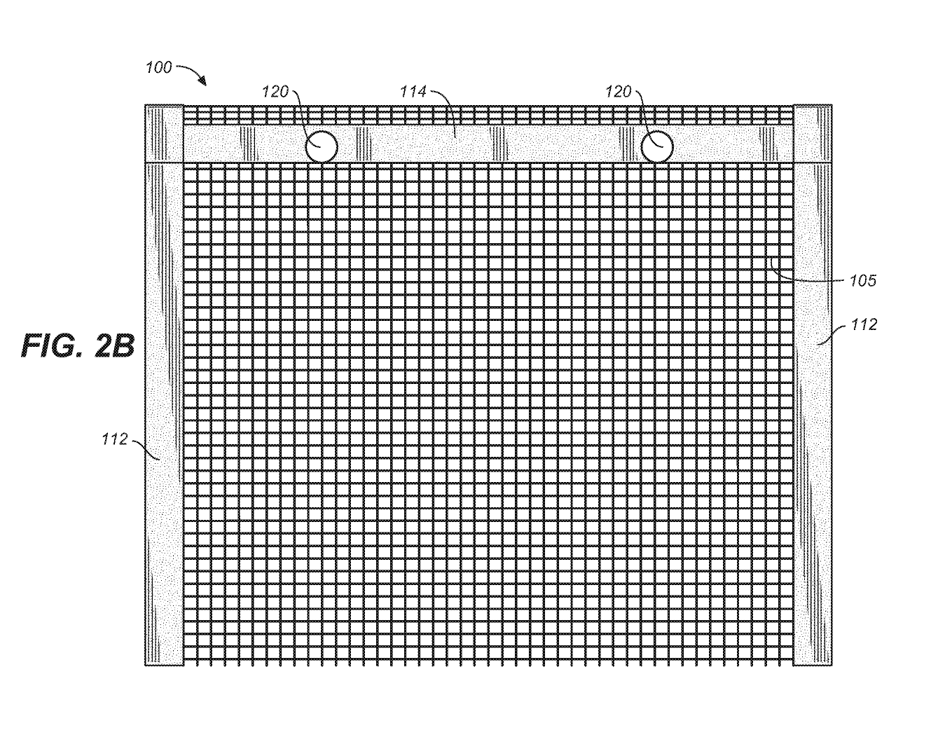

It is seen that an extended portion of the mesh fabric provides a foldable flap 111 for folding over the pouch's open mouth end 130 as shown in FIG. 2A after the pouch is filled. High temperature resistant fastening means 120, such as, for example, stainless steel snap fasteners, can be attached to or near the flap 111 to allow the flap to be releasably fastened down in a closed position as shown in FIG. 2B. Laterally extending strips of heat resistant tape 114 similar to the tape 112 used along the pouch's longitudinal border edges 109 can be provided at the top end of the pouch to seal the top edges of the mesh material and provide a reinforced base for fasteners 120.

The openings in the mesh material used to form the pouch are sized to prevent small food items from passing through, yet are sufficiently large to allow for the passage of heat and smoke through the pouch. Suitably, the size of the mesh openings is about 4 mm by 4 mm (0.157 inch by 0.157 inch), however, a material having larger or smaller mesh openings could be used. Generally, the mesh openings should be no greater than about 8 mm by 8 mm (0.315 inch by 0.315 inch).

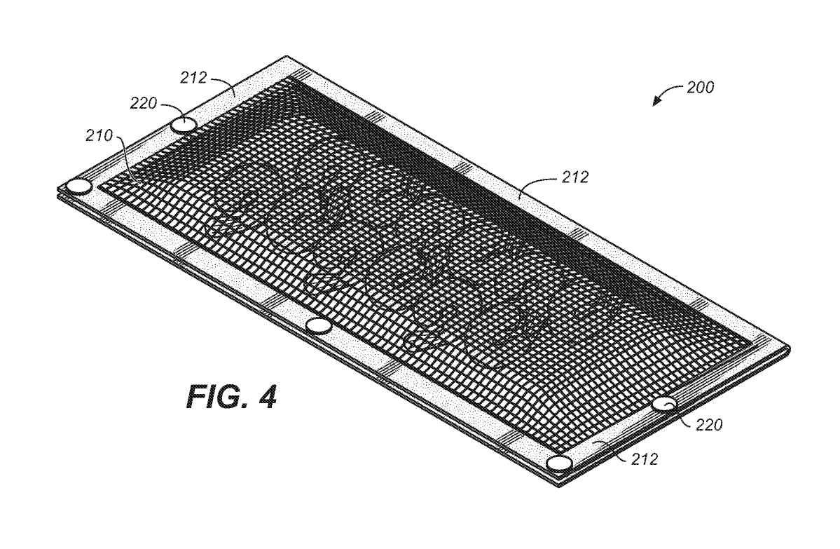

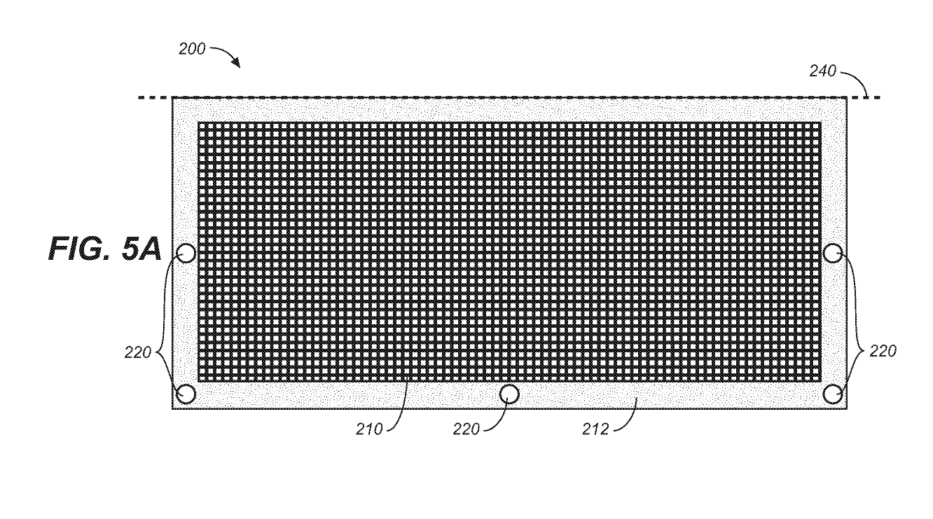

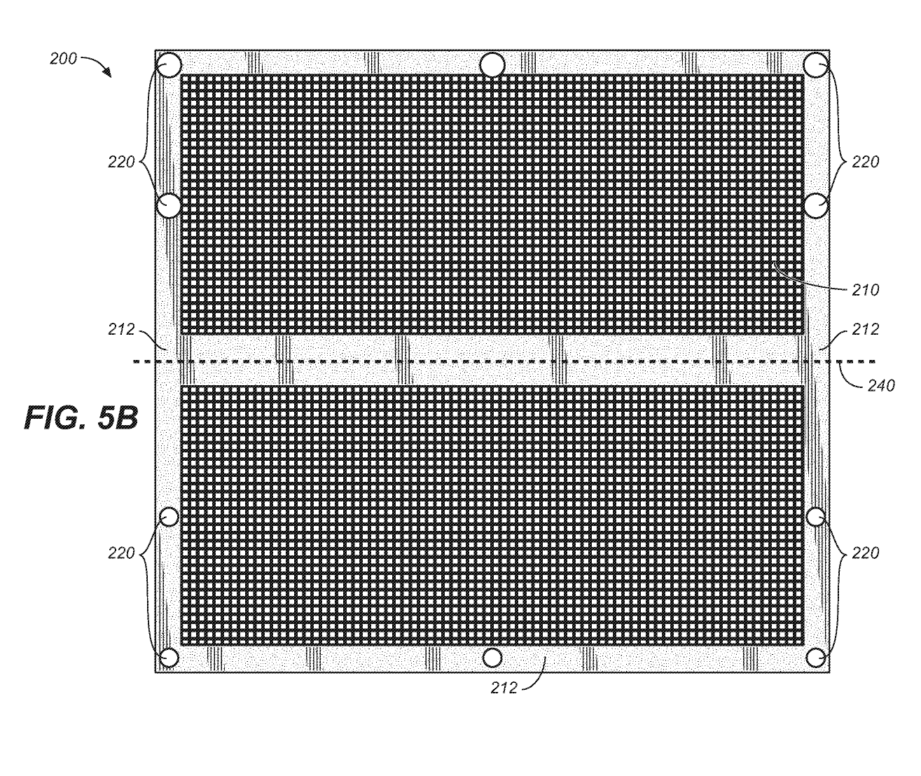

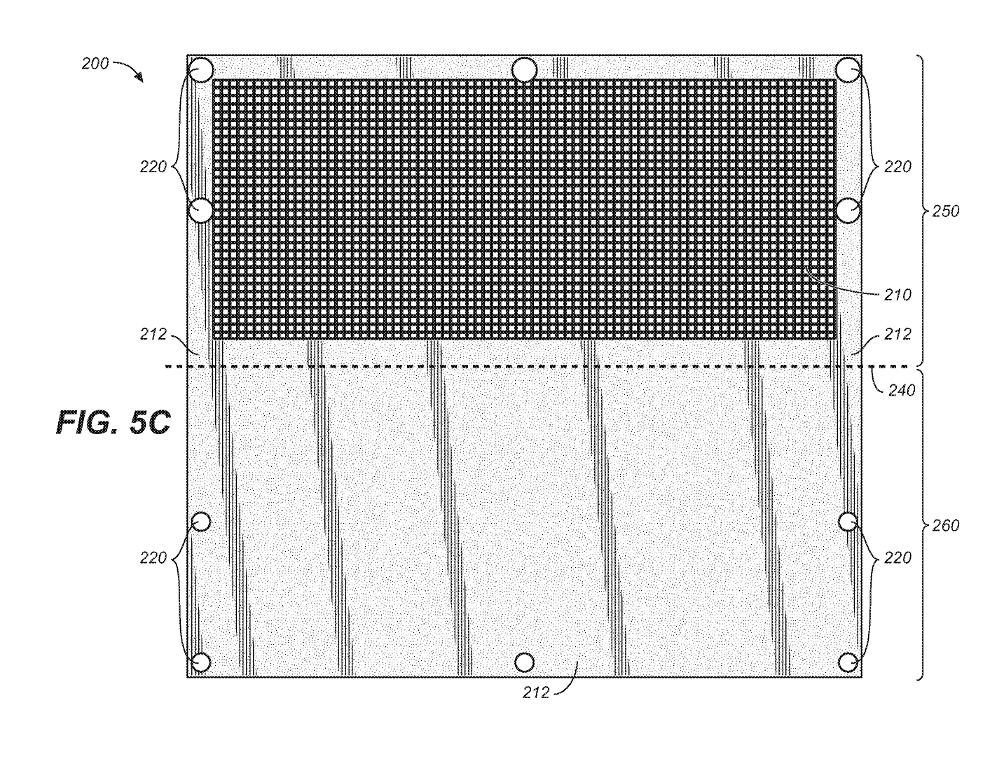

FIGS. 4-6 show a second embodiment of a grill bag in accordance with the invention in which the grill bag, denoted by the number 200, is not provided as a pre-formed pouch, but can instead be formed into a pouch by the user. Like the embodiment shown in FIGS. 1-3, the grill bag shown in FIGS. 4-6 is formed from a single piece of flexible, high temperature resistant material 210 having distributed mesh openings. But rather than being permanently sealed in pouch form along its longitudinal border edges, the grill bag in this embodiment includes snap fasteners 220 along all four of its border edges (FIG. 5B), which can be used to create the pouch. More particularly, the mesh material can be folded, for example, along fold line 240, to form a closed pouch configuration (FIG. 5A), similar to the pouch in the grill bag of FIGS. 1 to 2B. Alternatively, it can be laid out flat on a grill and used in an open configuration (FIG. 5B). The closed pouch configuration (FIG. 5A) can be used to cook smaller food items, while the open configuration (FIG. 5A) can be used for grilling larger, delicate food items such as a large piece of fish. In this embodiment of the grill bag, the high temperature resistant tape 212 is not used to permanently seal the grill bag in pouch form, but rather is used to affix the snap fasteners 220 to the border edges of the mesh material. High temperature tape is also used to provide reinforcement along the fold line 240. In addition to its functional purposes, the tape provides an aesthetic finish to the grill bag.

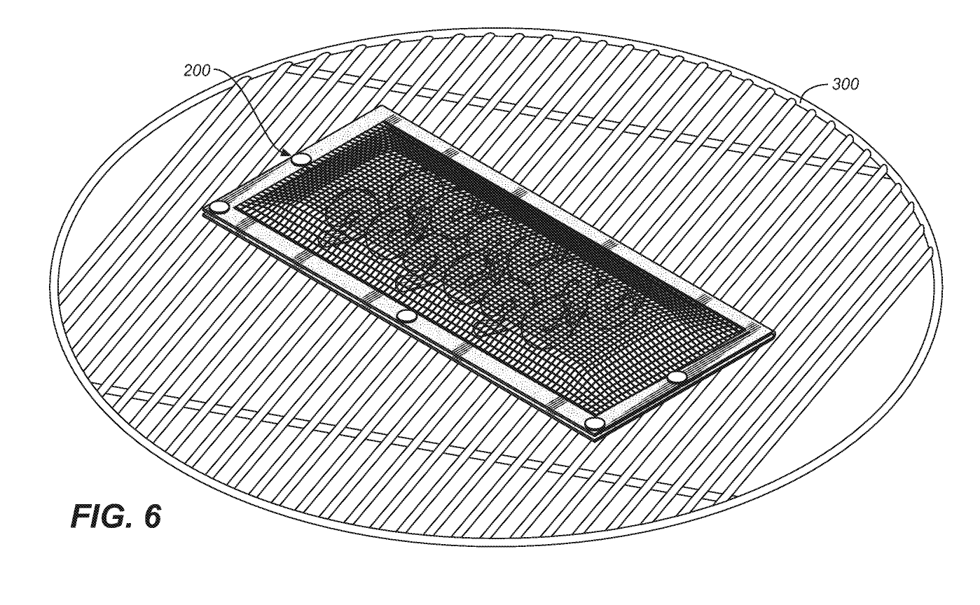

As mentioned above, the heat resistant material used to form the pouch of the grill bag need not have mesh openings throughout the material or on all sides of the pouch. FIG. 5C illustrates one example. The grill bag 200 shown in FIG. 5C is similar to the grill bag shown in FIGS. 5A and 5B, except that the mesh openings in the single piece of heat resistant material 210 are distributed over only one side of the pouch, denoted by the numeral 250, while the other side 260 has no openings, i.e. is solid. In this configuration, when the grill bag is used in the closed pouch configuration (FIG. 6), food items can either be exposed to smoke by placing the grill bag mesh side down on the grilling surface or can be shielded from smoke by placing the grill bag solid side down on the grilling surface.

While several embodiments of the invention have been described and illustrated herein in detail, it is not intended that the invention be limited to such detail, except as may be necessitated by the following claims. For example, while the embodiments of the grill bag back disclosed and illustrated herein all show a grill bag having a rectangular form, it will be understood that a grill back in accordance with the invention could be fashioned in other forms such as a circular, oval or hexagonal form. In such cases the starting heat resistant material or materials used to form the pouch would have the perimeter shape needed to form the grill bag of the desired shape. Also, materials other than the materials identified above could be used for the different parts of the grill bag, provided they have the high heat resistant properties needed for use in the high temperature environment encountered on a cooking grill.

What we claim is:

1. A grill bag for cooking small food items on a barbecue grill or the like, comprising:
a flexible pouch formed by at least one piece of flexible high temperature resistant material having distributed mesh openings wherein the distributed mesh openings have the following characteristics:
a. the mesh openings are sized to prevent small food items from passing through the mesh openings, and
b. the mesh openings are sufficiently large to allow the passage of heat and smoke through the mesh openings,
the flexible pouch being configured such that small food items can be placed in the pouch and such that the pouch containing the food items can be set on a barbecue grill or the like for cooking the small food items.

2. The grill bag of claim 1 wherein the grill bag is formed from a single piece of flexible high temperature resistant mesh material.

3. The grill bag of claim 1 wherein the size of the mesh openings in the flexible high temperature resistant material is no greater than about 8 mm by 8 mm (0.315 inch by 0.315 inch).

4. The grill bag of claim 1 wherein the size of the mesh openings of the flexible high temperature resistant material is about 4 mm by 4 mm (0.157 inch by 0.157 inch).

5. The grill bag of claim 1 wherein the mesh openings of the flexible high temperature resistant material are distributed over substantially the entirety of the flexible high temperature resistant material and hence the flexible pouch.

6. The grill bag of claim 1 wherein the pouch has a top end and an opening in the top end through which small food items can be inserted into the pouch.

7. The grill bag of claim 6 wherein the flexible high temperature resistant material forming the pouch is configured to provide an extended foldable flap at the top end of the pouch that can fold over the top end of the pouch after small food items have been placed in the pouch.

8. A grill bag for cooking small food items on a barbecue grill or the like, comprising:
a flexible high temperature resistant mesh material having distributed mesh openings wherein the mesh openings have the following characteristics:
a. the mesh openings are sized to prevent small food items from falling through the mesh openings, and
b. the mesh openings are sufficiently large to allow the passage of heat through the mesh openings,
said mesh material being configured into the form of a mesh pouch into which small food items can be inserted, wherein the mesh pouch can be loaded with small food items and set on a barbecue grill or the like for cooking the small food items contained within the pouch.

9. The grill bag of claim 8 wherein the mesh pouch is configured from a single piece of flexible high temperature resistant mesh material having opposite longitudinal border edges and that can be folded over to produce opposing folded-over parts of the mesh material, and wherein fastening means are provided on the longitudinal border edges of the mesh material for fastening the opposing folded-over parts of the mesh material together to form the mesh pouch.

10. The grill bag of claim 9 wherein the fastening means are releasable fastening means wherein the opposing folded-over parts of the mesh material can be unfastened to optionally lay the mesh material flat on a barbeque grill or the like.

11. The grill bag of claim 9 wherein the fastening means on the border edges of the opposing folded-over parts of the mesh material fixedly secure the folded-over parts together to maintain the mesh material in a pouch form.

12. The grill bag of claim 8 wherein the size of the mesh openings of the mesh material forming the mesh pouch is no greater than about 8 mm by 8 mm (0.315 inch by 0.315 inch).

13. The grill bag of claim 8 wherein the size of the mesh openings of the mesh material forming the mesh pouch is about 4 mm by 4 mm (0.157 inch by 0.157 inch).

14. The grill bag of claim 8 wherein the heat tolerant mesh material is a polytetrafluoroethylene (PTFE) coated fiberglass mesh fabric.

15. A grill bag for cooking small food items on a barbecue grill or the like, comprising:
a flexible high temperature resistant mesh material having mesh openings no greater than about 8 mm by 8 mm (0.315 inch by 0.315 inch), the mesh material being capable of being folded over to produce opposing folded-over parts,
the mesh material having opposite longitudinal border edges and fastening means on the longitudinal border edges of the mesh material for fastening the opposing folded-over parts of the mesh material together to form a mesh pouch, the mesh pouch being so formed that small food items can be inserted into the mesh pouch, wherein the mesh pouch can be loaded with small food items and set on a barbecue grill or the like for cooking the small food items contained within the pouch.
